(19) United States
(12) Patent Application Publication
(10) Pub. No.: US 2006/0085454 A1
(43) Pub. Date: Apr. 20, 2006

(54) Systems and methods to relate multiple unit level datasets without retention of unit identifiable information

(76) Inventors: John L. Blegen, Eau Claire, WI (US); Andrew R. Rolfe, East Dundee, IL (US)

Correspondence Address: WELSH & KATZ, LTD, 120 S RIVERSIDE PLAZA, 22ND FLOOR, CHICAGO, IL, 60606, US

(21) Appl. No.: 11/244,968

(22) Filed: Oct. 6, 2005

Related U.S. Application Data
(60) Provisional application No. 60/616,251, filed on Oct. 6, 2004.

(51) Int. Cl. G06F 17/30

(52) U.S. Cl. 707/100

(57) ABSTRACT

A method by which researchers may receive unit level data (individual person records) from multiple sources and aggregate that data without receiving personally identifiable data. Since the unconstrained aggregation of seemingly non-identifying data elements can eventually lead to subject identification, the aggregation is limited to a predefined data aggregation domain.

### CROSS REFERENCE TO RELATED APPLICATION

This application claims the benefit of the filing date of U.S. Provisional Application Ser. No. 60/616,251 filed Oct. 6, 2004 and entitled “Method To Relate Multiple Unit Level Datasets Without Retention Of Unit Identifiable Information”.

### FIELD

The invention pertains to systems and methods that provide information relative to members of a plurality of interest. More particularly, the invention pertains to such systems and methods where the information can be provided but the identities of the members of the plurality are shielded and not provided.

### BACKGROUND

There are situations where a dataset user (a researcher for example) will have a legitimate need for UNIT LEVEL DATA (ULD) (for example, data describing an individual person) but does not need or want personally identifiable data such as name, address, phone, social security number (SSN), biometric identifiers and/or samples. The problem comes when the dataset user needs to aggregate data from multiple sources to create a research dataset. In order to relate data from multiple sources it is essential to have a unique key (often, although not necessarily SSN) through which the UNIT LEVEL DATA can be related.

For example, a dataset user such as a state Board of Regents collects large amounts of data on students at its higher education institutions. Data are used :in research and often lead to the establishment of educational policy. Data come from multiple sources including educational institutions, the Department of Labor, and other federal and private sources. Typically the primary key for all of these datasets is SSN. This creates privacy concerns and makes gathering of data more difficult.

Sources may be unwilling to provide useful data along with the primary key. The dataset user incurs additional security cost and disclosure risk related to holding the primary key when provided. Since the data may be retained indefinitely, the risk of disclosure or misuse also continues indefinitely.

Dataset users may even be forbidden by law from collecting information identifying individuals. This makes multiple data source and longitudinal studies difficult or impossible.

There is thus an on-going need for improved systems and methods for mining, obtaining or amalgamating information form a plurality of sources. Preferably, where the information relates to individuals, the identifies of all such individuals will be excluded from the provided information; and unavailable.

### BRIEF DESCRIPTION OF DRAWINGS

FIG. 1 is block diagram of an example of a Anonymous Key Authority system that is network based.

FIG. 2 is a block diagram which illustrates the steps taken at each Data Provider in accordance with the invention.

FIG. 3 is a block diagram which illustrates the steps taken at the Anonymous Key Authority in accordance with the invention. The dashed lines are used to indicate optional steps.

FIG. 4 is a block diagram which illustrates the steps taken at the Dataset User in accordance with the invention. The dashed lines are used to indicate optional steps.

### DETAILED DESCRIPTION OF INVENTION

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

A method that embodies the invention converts a Personally Identifiable Key (PIK) such as SSN (or any combination of personally identifiable data) into another unique Anonymous Key (AK) that is limited in scope to a defined dataset (DATASET DOMAIN) and that cannot be connected to the originating individual. The new unique Anonymous Key could be created in the same manner from all data sources, therefore the records could be linked together by the dataset user. A common application would be the use of a single AK. However, the DATASET DOMAIN need not be limited to specifying a single AK. Multiple AKs can be created using different PIKs from all of the data providers.

Neither the data provider nor the dataset user should make the conversion from PIK to AK since the party making the conversion would have access to both the PIK and the new AK, and therefore provide a potential means for linking back to the identifiable information. By use of a third party, known here as an Anonymous Key Authority (AKA), who processes the one-way translation, the relationship between the new Anonymous Key and the PIK is protected. To protect the independence of the AKA, the AKA would have access to the PIK only, without having access to the ULD.

In a disclosed embodiment, the scope is preferably limited to a fixed DATASET DOMAIN. Hence, advantageously, multiple independent datasets cannot be further aggregated for unintended uses. Neither compromising the data, nor future change in privacy policy can reestablish the relationship between the personally identifiable data and the research data.

Further, in a disclosed embodiment:

The PIK to AK conversion is one-way, and not reversible. One such method is a standard secure hashing algorithm (for example SHA-1 as described in Federal Information Processing Standards Publication 180-1).

The new collection of data cannot have elements that become personally identifiable through further aggregation with other elements.

The AK will only be valid within an agreed domain of providers and datasets, in order to enforce condition two above. The combination of datasets to be linked is the DATASET DOMAIN.

In order to enforce condition two, there must be an agreement (DOMAIN AGREEMENT) controlling the scope and format of data to be aggregated under the AK. This agreement must be between the dataset user (user of the UNIT LEVEL DATA) and all the data providers. Optionally this agreement can also specify a requirement for an Audit Trail to be kept by the AKA.

In order to protect the anonymity of the new AK, no party can have access to all three components: a) the original identifiable key (PIK) or its associated hash; b) the new AK; and c) the UNIT LEVEL DATA.

For example, the provider of the UNIT LEVEL DATA and the holder of the PIK must not know the association of an AK with any record. The trusted third party who converts the PIK to the AK must not need the UNIT LEVEL DATA for any key. The recipient who uses the AK and the UNIT LEVEL DATA must not know the association of the PIK with any AK.

A method to relate multiple unit level (individual person) datasets without disclosure or retention of unit identifiable information and with no party other than the original holder of the data ever having access to both the data of interest (research data elements) and the personally identifiable data (PIK). This is done by replacing the personally identifiable data (PIK) with an anonymous key (AK). The process includes the steps of: 1) Establishing a domain of data providers who agree to share elements of their datasets without personally identifiable information. 2) A means of transmitting the source data records to an Anonymous Key Authority so the AKA does not have access to the research data elements (non-key data of interest). 3) A means to generate a consistent Anonymous Key (AK) to replace the personally identifiable key that will be unique to the contract domain. 4) A means to transmit the records to the recipient tin a way that the recipient can receive the Anonymous Key and decrypt the associated non identifying data value (research data elements).

A method by which researchers may receive unit level data (individual person records) from multiple sources and aggregate that data without receiving personally identifiable data. Since the unconstrained aggregation of seemingly. non-identifying data elements can eventually lead to subject identification, the aggregation is limited to a predefined data aggregation domain. The process is not reversible unless a reversibility option is chosen in advance, and only with the participation of multiple parties (the originating Data Provider, the Anonymous Key Authority, and the dataset user. Distinct roles and processes are defined for Data Provider, Anonymous Key Authority, and dataset user so that no party has access to the both the personally identifying data and the newly aggregated research data.

In yet another aspect of the invention, an Optional Process whereby a reversible algorithm can be used in place of the non-reversible one-way hash. This would allow the holder of the encryption key to reverse the process and identify the source PIK at some future time and with proper authority. The reversible method is only implemented if it is agreed to as part of the original domain agreement.

This reversible process might be chosen, for example, in medical research situations where the research might discover a dangerous but treatable condition in a research dataset and ethics would require notification of the individual subject.

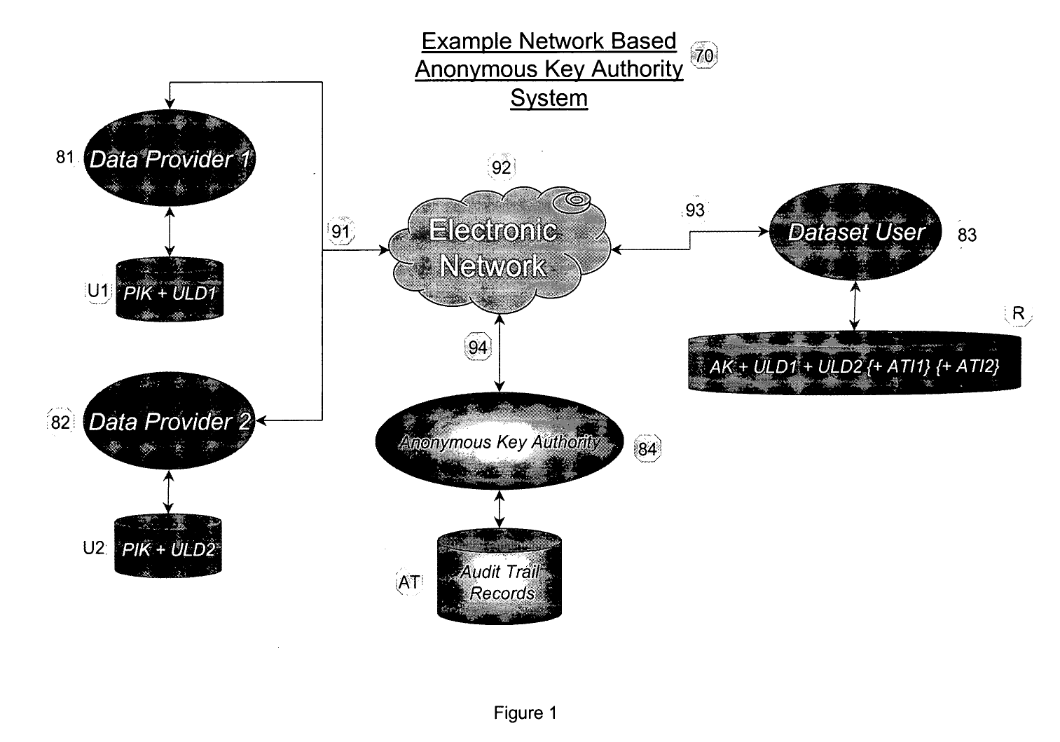

With Reference to FIG. 1, an example system 70 that implements the process is shown using an electronic network to provide communication between the parties of the transactions. This is to be considered as an exemplification of the principles of the invention and is not intended to limit the invention to the specific embodiments illustrated.

Two or more data providers 81, 82 have UNIT LEVEL DATA U1 U2 that is identified by PIKs. The data providers enter into an agreement with a Dataset User 83 and the ANONYMOUS KEY AUTHORITY (AKA) 84 to share the UNIT LEVEL DATA but not the PIKs. The datasets are pre-processed and encrypted by the Data Providers so the ULD is not available to the AKA.

The datasets are transmitted 91, 92, 94 to the AKA 84. The AKA receives the pre-processed source datasets and substitutes domain based anonymous keys (AK) for the PIKs. The modified datasets with AK substituted for PIK are transmitted 94, 92, 93 to the dataset user who is able to join the two datasets by AK without having access to the PIKs. Optionally, if and only if included in the domain agreement, and audit trail AT is retained by the AKA which would allow controlled identification of the original PIK under specific conditions.

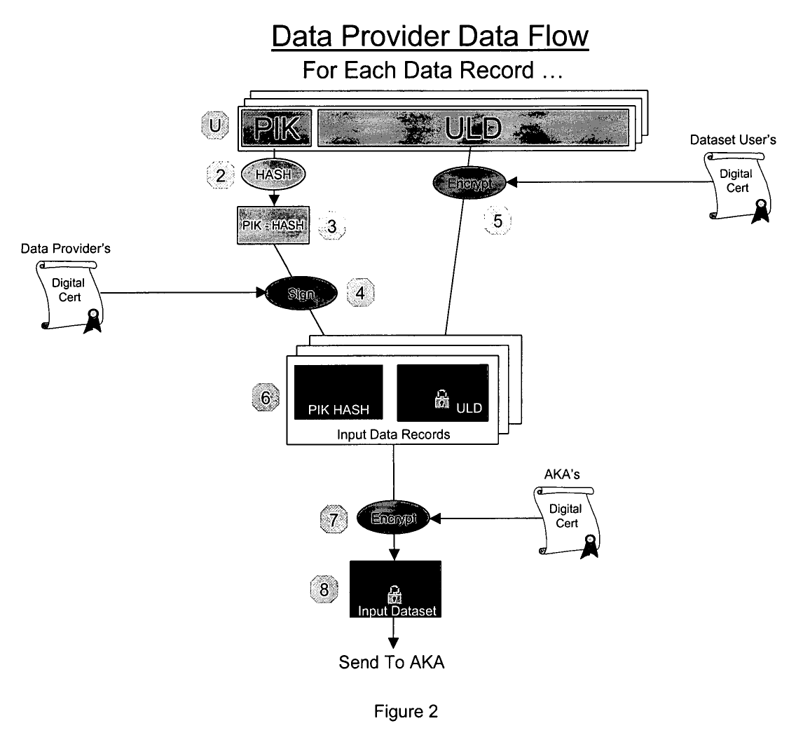

With reference to FIG. 2, the Data Providers encrypt 5 (using any standard asymmetric encryption method) the UNIT LEVEL DATA of each data record with the dataset user's public key. This allows the record to be transmitted to the AKA without providing the AKA access to the UNIT LEVEL DATA. The Data Provider converts 2 the PIK of each data record using a one-way hash, and then encrypts 4 (using a standard asymmetric encryption method) the PIK hash using the Data Provider's private key (also known as signing).

The Data Provider builds a dataset 6 of input records (which includes the signed PIK hash 3 and the encrypted UNIT LEVEL DATA) and encrypts 7 (using a standard asymmetric encryption method) the dataset with the Anonymous Key Authority's public key. The encrypted dataset 8 is sent by any appropriate means to the Anonymous Key Authority.

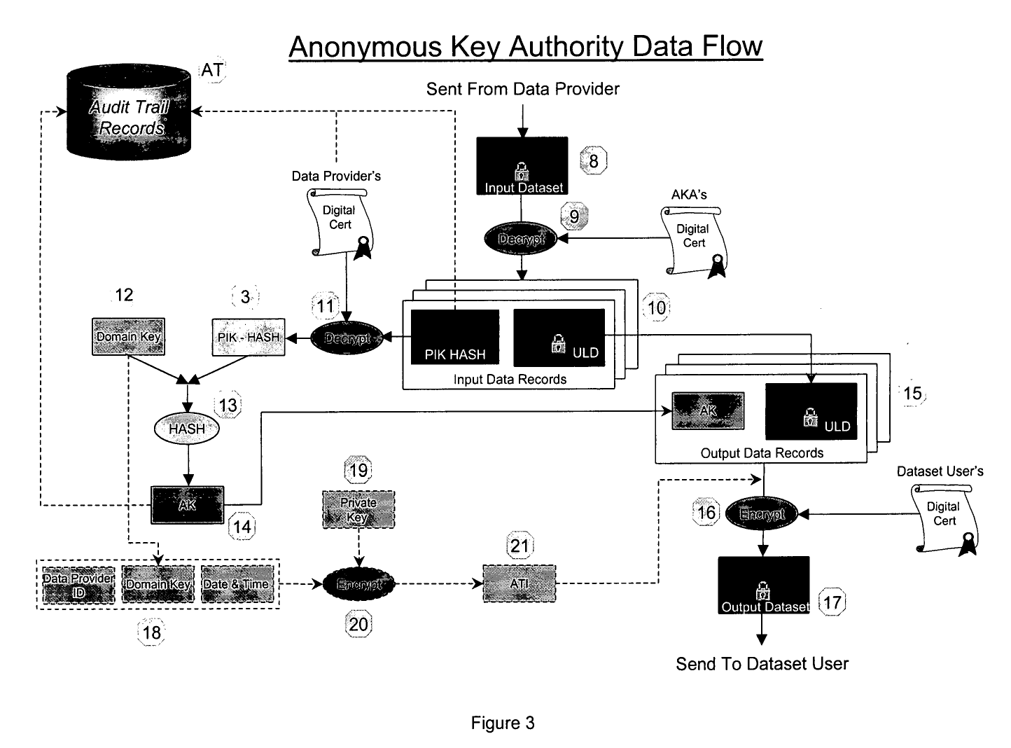

With reference to FIG. 3, the Anonymous Key Authority decrypts 9 the dataset 8 with its private asymmetric key. The AKA now has access to the unencrypted PIK hash 3 (via decryption 11 using the data provider's public key), but no access to the unencrypted UNIT LEVEL DATA. The PIK hash 3 and a secret DOMAIN KEY 12 are combined using a non-reversible algorithm 13 (such as a standard secure hashing algorithm) to generate a unique Anonymous Key 14 for each record. The processing, or, algorithm used must stay consistent throughout the lifetime of the DATASET DOMAIN.

The DOMAIN KEY 12 is a secret key held by the AKA that is unique to a specific DATASET DOMAIN. The DOMAIN KEY represents the agreement between data providers and dataset user. Each newly generated AK is combined with the encrypted UNIT LEVEL DATA (as received from the data provider) to build a new dataset of records 15 (without the original PIK). This new dataset is encrypted 16 (using a standard asymmetric encryption method) with the dataset user's public key. The encrypted dataset 17 is sent by any appropriate means to the dataset user.

Optionally, if and only if stipulated by the DOMAIN AGREEMENT, a special Audit Trail provision can make it possible for the AKA to trace a record back to the source data provider. If the Audit Trail is stipulated, the dataset user must also receive an Audit Trail Identifier (ATI) 21 within each dataset from the AKA. The ATI is generated at the AKA by encrypting 20 (with a private symmetric key 19) the combination 18 of the date and time (when the data was received at the AKA from the Data Provider), the DOMAIN KEY and a data provider identifier.

Since the AKA can retain all three of these elements that make up the ATI within the AKA Audit Trail records AT, the AKA can validate and verify all these elements at a later date when provided an ATI from a dataset user (for example when the research shows some anomaly in a certain dataset that ethically should be communicated back to the original data provider).

Optionally, the AKA can also retain the AK 14, the signed PIK hash from the Data Provider, along with the Data Provider's public encryption key within the AKA Audit Trail records AT. Such an Audit Trail would allow the AKA to trace a specific AK (with ATI) back to the source Data Provider and PIK hash if necessary. This Would not provide the actual PIK, but with the help of the Data Provider, a brute force recalculation of all the PIK hashes of all the records in the dataset sent by the Data Provider at that date and time could determine the original individual.

This optional process might be chosen, for example, in medical research situations where the research might discover a dangerous but treatable condition in a research dataset and ethics would require notification of the individual subject.

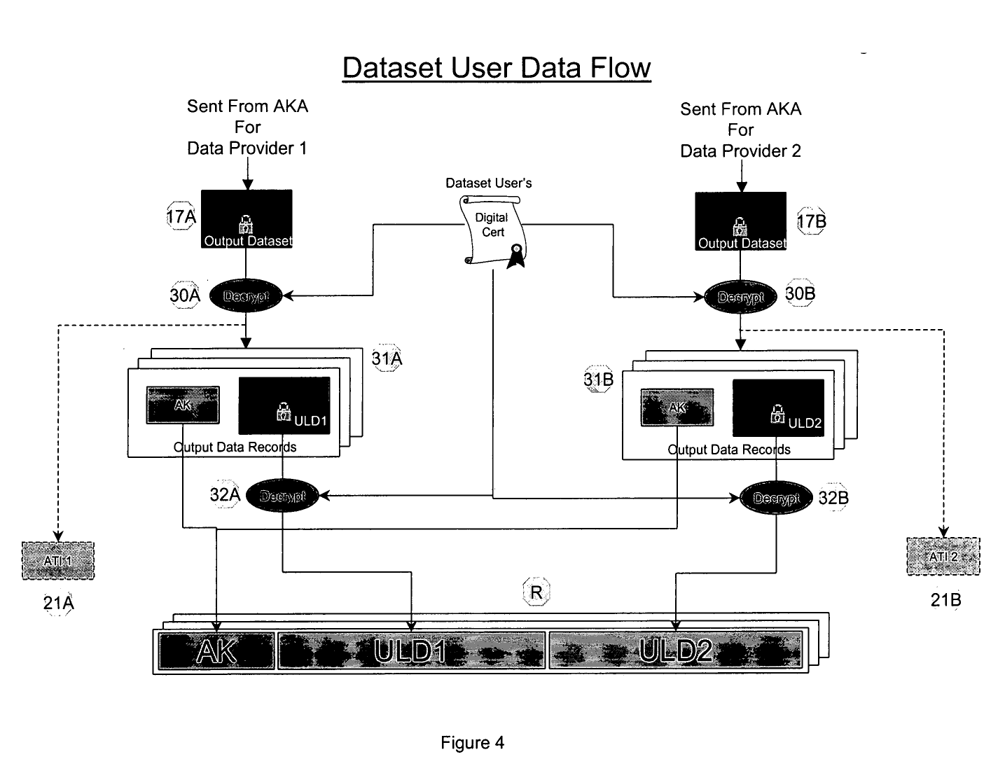

Relative to FIG. 4, the dataset user decrypts 30 with its private asymmetric key the new dataset 31 which contains the Anonymous Key and the encrypted UNIT LEVEL DATA. The dataset user decrypts 32 with its private asymmetric key the UNIT LEVEL DATA from the Data Provider, which is now ready for use. The dataset user has UNIT LEVEL DATA but no direct means of linking that data to personally identifiable information.

The new combined dataset R cannot be linked to any other dataset outside of the agreed upon DATASET DOMAIN because the Anonymous Keys were generated with the unique DOMAIN KEY and are therefore unique to the DATASET DOMAIN. If the DOMAIN AGREEMENT stipulates an Audit Trail be kept at the AKA, then the dataset user will also receive an ATI 21A, 21B within the datasets from each Data Provider. If the dataset user wishes to have the potential to trace UNIT LEVEL DATA back to a specific Data Provider, the dataset user must keep the AK and the ATI bound to the UNIT LEVEL DATA.

The Anonymous Key Authority preferably undertakes the following responsibilities:

a) Maintain the DOMAIN AGREEMENT, which specifies the agreements between the data providers and the dataset user. This DOMAIN AGREEMENT will typically specify what UNIT LEVEL DATA are to be provided by each provider and the format of that data, in order to insure that the datasets do not become personally identifiable through aggregation. This DOMAIN AGREEMENT will also specify what the data and the format will be used for the Personally Identifiable Key. The DOMAIN AGREEMENT will also specify the review and approval steps required to add additional providers or additional UNIT LEVEL DATA to the DATASET DOMAIN (if such amendments are allowed at all).

b) Generate and maintain a copy of the secret and unique DOMAIN KEY that guarantees that the generated Anonymous Keys are limited to the data shared through this DATASET DOMAIN.

c) Maintain the key generation algorithm insuring a secure non-reversible Anonymous Key that is consistent throughout out the life of the DATASET DOMAIN.

d) Receive, process, and forward records within agreed upon service level.

e) Optionally generate Audit Trail Identifiers to be provided to the recipient, and maintain a copy of any data elements that, in addition to the recipients AK and ATI, are necessary to provide a link back to the originating Data Provider.

In yet another alternate, the anonymous key can be returned to the data provider for data sharing purposes. In this embodiment, a new key can be formed by combining a selected domain “seed” and the personally identifiable key.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method of replacing a personally identifiable key with an anonymous key comprising:
establishing a domain of data providers who agree to share elements of their datasets without personally identifiable information in accordance with a domain agreement;
transmitting the source data records to an anonymous key authority, the authority does not have access to non-key data of interest;
generating a consistent anonymous key to replace each personally identifiable key, the anonymous key being unique to the domain agreement;
transmitting the records to the recipient such that the recipient can receive the anonymous key and decrypt the associated non-identifying data values.

2. A method as in claim 1, wherein the scope over which the data records can be linked is limited to the data provided by the parties to the domain agreement.

3. A method as in claim 1, wherein the scope of the domain agreement can be altered by the consent of all responsible parties.

4. A method as in claim 1, wherein the data provider can encrypt the data records so that the key authority can decrypt only a personally identifiable key but no associated data elements, and by which only the data recipient can decrypt the data elements, but does not receive the personally identifiable key.

5. A method as in claim 1, where the anonymous key authority implements a selected one-way hash encryption process to generate an anonymous key that is consistent when generated with the same combination of domain and personally identifiable key, is limited in scope to the domain, and is non-reversible.

6. A method as in claim 1, wherein the anonymous key provider can encrypt the combination of anonymous key and non-key data, exclusive of the original personally identifiable key, so that the recipient can decrypt the new anonymous key and also decrypt the associated data elements.

7. A method as in claim 1, wherein the domain agreement defines a shared definition of the specification of the personally identifiable key to be used in the process.

8. A method as in claim 1, wherein a domain agreement defines a substantially complete list of data items to be shared by all parties, thus enabling each party to the agreement to be satisfied that risk of individual identification through data aggregation is at a predetermined, selected low level.

9. A method as in claim 1, wherein multiple domains, even if generated in whole or in part from the same sources, can not be further aggregated.

10. A method as in claim 1 wherein participants and components are isolated so that encrypted personally identifiable data, anonymous keys, and associated non-key data elements are never in clear text on the same system.

11. A system comprising:
at least one data provider;
first software that provides a plurality of records, from the data provider, each record having a personal identifier section and an encrypted data section;
an anonymous key authority;
second software that removes the identifier section and associates with each member of the plurality a new identifier which can not disclose the individual identifier; and
third software that combines the new identifier with one or more respective encrypted data sections.

12. A system as in claim 11 where the anonymous key authority executes the second software.

13. A system as in claim 11 which includes fourth software that encrypts the combined new identifier and respective data sections.

14. A system as in claim 11 where the anonymous key authority executes the third and fourth software.

15. A system as in claim 11 where the anonymous key authority maintains an audit trail.

16. A system as in claim 11 which includes an agreement between at least the one data provider and an intended recipient, maintained by the anonymous key authority relative to at least the records.

17. A system as in claim 11 which includes software to transfer the combined identifiers and encrypted data sections to at least one recipient.

18. A system as in claim 16 which includes software to transfer the combined identifiers and encrypted data sections to at least one recipient.

19. A system as in claim 11 where the at least one data provider includes software that encrypts both the identifier section and the data section.

20. A system as in claim 19 where the key authority can decrypt the identifier section to the exclusion of the data section.

21. A system as in claim 20 where an intended end user recipient can decrypt the data section without having access to the respective identifier section.

22. A method of replacing a personally identifiable key with an anonymous key comprising:
establishing a domain of data providers who agree to share elements of their datasets without personally identifiable information in accordance with a domain agreement;
transmitting the source data records to an anonymous key authority, the authority does not have access to non-key data of interest;
generating a consistent anonymous key to replace each personally identifiable key, the anonymous key being unique to at least portions of the personally identifiable key and the domain agreement; and
transmitting the records to the recipient such that the recipient can receive the anonymous key and decrypt the associated non-identifying data values.

23. A method as in claim 22 which includes generating at least a second consistent anonymous key, the second key being unique to at least portions of the personally identifiable key and the domain agreement.

24. A method as in claim 22 which includes generating a plurality of different, consistent anonymous keys, the members of the plurality being unique to at least portions of the personally identifiable key.
